(19) United States
(12) Patent Application Publication
(10) Pub. No.: US 2010/0016564 A1
(43) Pub. Date: Jan. 21, 2010

(54) METHOD OF PREPARING AN IMMOBILISED METAL ION CHROMATOGRAPHY ADSORBENT AND METHODS OF PURIFYING PROTEINS, PEPTIDES OR POLYNUCLEOTIDES

(75) Inventors: Lars C. Andersson, Uppsala (SE); Makonnen Belew, Uppsala (SE); Tesfai Gebru, Uppsala (SE); Gunnar Glad, Uppsala (SE); Helena Lindgren, Uppsala (SE); Nils Norrman, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, Uppsala (SE)

(21) Appl. No.: 12/297,241

(22) PCT Filed: May 28, 2007
(86) PCT No.: PCT/SE2007/000513

§ 371 Date: Oct. 15, 2008

(30) Foreign Application Priority Data
May 30, 2006 (SE) 0601231-4

(51) Int. Cl. C07K 1/22; C07H 23/00

(52) U.S. Cl. 530/413; 536/121

(57) ABSTRACT

The present invention relates to a method of preparing an immobilised metal ion affinity chromatography (IMAC) adsorbent, which comprises to provide chromatography ligands comprised of alkylene diamine triacetic acid, or a derivative thereof, and coupling thereof to a carrier via nitrogen. In an advantageous embodiment, the alkylene diamine triacetic acid is ethylene diaminetriacetic acid (ED3A).

### CROSS-REFERENCE TO RELATED APPLICATIONS

This application is a filing under 35 U.S.C. § 371 and claims priority to international patent application number PCT/SE2007/000513 filed May 28, 2007, published on Dec. 6, 2007, as WO 2007/139470, which claims priority to patent application number 0601231-4 filed in Sweden on May 30, 2006.

### FIELD OF THE INVENTION

The present invention relates to the field of chromatography, and more specifically to the preparation of an immobilised metal ion affinity chromatography (IMAC) adsorbent.

### BACKGROUND OF THE INVENTION

Biotechnological methods are used to an increasing extent in the production of proteins, peptides, nucleic acids and other biological compounds, either for research purposes or for industrial scale preparation of drugs and diagnostics. Due to its versatility and sensitivity to the compounds, chromatography is often the preferred purification method in this context. The term chromatography embraces a family of closely related purification methods, which are all based on the principle that two mutually immiscible phases are brought into contact. More specifically, the target compound is introduced into a mobile phase, which is contacted with a stationary phase. The target compound will then undergo a series of interactions between the stationary and mobile phases as it is being carried through the system by the mobile phase. The interactions exploit differences in the physical or chemical properties of the components in the sample.

In a chromatographic purification method known as immobilised metal ion affinity chromatography (IMAC), interactions between a target compound and metal ions chelated to the stationary phase are utilised. IMAC, which is also known as metal chelating affinity chromatography (MCAC), is often used for the purification of proteins, especially so called histidine-tagged proteins. The principle behind IMAC lies in the fact that many transition metal ions can form coordination bonds between oxygen and nitrogen atoms of amino acid side chains in general and of histidine, cysteine, and tryptophan, in particular. To utilise this interaction for chromatographic purposes, the metal ion must be immobilised onto an insoluble support. This can be done by attaching a chelating group to the support. Most importantly, to be useful, the metal ion of choice must have a significantly higher affinity for the matrix than for the compounds to be purified. Examples of suitable coordinating metal ions are Cu(II), Zn(II), Ni(II), Ca(II), Co(II), Mg(II), Fe(III), Al(III), Ga(III), Sc(III) etc. Various chelating groups are known for use in IMAC, such as iminodiacetic acid (IDA), which is a tridentate chelator, and nitrilotriacetic acid (NTA), which is a tetradentate chelator. The chelating groups are commonly known as IMAC ligands, while the insoluble support is known as a carrier or base matrix.

U.S. Pat. No. 6,441,146 (Minh) relates to pentadentate chelator resins, which are metal chelate resins capable of forming octahedral complexes with polyvalent metal ions with five coordination sites occupied by the chelator, leaving one coordination site free for interaction with target proteins. It is suggested to use the disclosed chelator resins as universal supports for immobilizing covalently all proteins, using a soluble carbodiimide. More specifically, the disclosed pentadentate chelator resin is prepared by first reacting lysine with a carrier, such as activated SEPHAROSE™. The resulting immobilized lysine is then carboxylated into a pentadentate ligand by reaction with bromoacetic acid.

Marian et al (Talanta, Vol. 36, No. ½, pp. 341-346, 1989: “On the nature of immobilized tris(carboxymethyl)ethylenediamine”) relates to immobilized pentadentate chelator, namely tris(carboxymethyl)ethylenediamine, also known as TED, used as IMAC stationary phases for protein fractionation. The TED resins were obtained by immobilization of ethylene diamine to a carbohydrate support, and subsequent carboxylation to provide the chelating carboxylic groups. The experimental evidence in the article shows that commercial TED-resins does not have the structure indicated by manufacturer. Instead, it appears to be a mixture of ligands, with ethylenediamine-N,N′-diacetic acid (EDDA) predominant. The article also reports a large discrepancy between theoretical capacity determined from the nitrogen content and the experimental capacities, which indicate that a large proportion of the nitrogen is in a form that does not bind to metal ions.

EP 1 244 612 (Akzo Nobel) relates to a process of preparing alkylene diamine triacetic acid and derivatives thereof. More specifically, a process is disclosed, which comprises the conversion of alkylene diamine to a salt of alkylene diamine triacetic acid wherein the reaction is carried out in the presence of a polyvalent metal ion and the entire reaction is carried out under hydrolyzing conditions if any of the reactants contain or form nitrile or amide groups. The suggested use of these compounds is in the field of chelating chemistry, such as metal cleaning.

In the field of IMAC much effort has been placed on providing an adsorbent with a high adsorption capacity. However, the cells and the fermentation broth wherein a recombinant target protein is produced will also contain other proteins produced by the host cell, generally denoted host cell proteins (HCP), some of which will also adsorb to the adsorbent and require elution conditions separate from that used for the target protein. Thus, there is a need in this field of an IMAC adsorbent, which adsorbs less host cell proteins and/or which presents an improved selectivity allowing selective elution of target proteins.

### SUMMARY OF THE INVENTION

A first aspect of the invention relates to a method of preparing an immobilised metal ion affinity chromatography (IMAC) adsorbent, which method results in a highly homogenous product. This can be achieved by a method as defined in the appended claims.

Another aspect of the invention is to provide an immobilised metal ion affinity chromatography (IMAC) adsorbent, which presents an improved selectivity when used in protein purification as compared to the prior art products.

A further aspect of the invention is to provide an immobilised metal ion affinity chromatography (IMAC) adsorbent, which presents reduced metal ion leakage when used in protein purification as compared to the prior art products.

Yet another object of the present invention is to avoid the high concentrations of imidazole commonly required in the adsorption buffer used as mobile phase in IMAC. This can be achieved by a method of protein and/or peptide purification as defined in the appended claims.

A specific aspect of the invention is to provide a method of protein and/or peptide purification from animal cell culture liquids. This can be achieved by using an adsorbent prepared according to the present invention.

Further aspects and advantages of the present invention will appear from the detailed description and examples below.

### BRIEF DESCRIPTION OF THE DRAWINGS

FIG. 1 shows one way of synthesizing an alkylene diamine triacetic acid, namely ED3A, which can be used in the method according to the invention.

FIG. 2 shows the coupling according to the invention of the purified pentadentate ligand of FIG. 1 to a carrier (“gel”).

FIG. 3 shows the chromatograms obtained using the IMAC adsorbent according to the invention as described in Example 3 below.

FIG. 4 shows the chromatograms obtained using a commercially available pentadentate as described in Example 4 below.

### DEFINITIONS

The term chromatography “adsorbent” is used herein for an insoluble carrier to which chromatography ligands are attached. The insoluble carrier may be porous or non-porous.

### DETAILED DESCRIPTION OF THE INVENTION

The present invention relates to the preparation of an IMAC adsorbent by first synthesizing the ligands in solution; and then coupling the so synthesized ligands to a carrier, optionally after a purification step. More specifically, in a first aspect, the present invention relates to a method of preparing an immobilised metal ion affinity chromatography (IMAC) adsorbent, which comprises to provide chromatography ligands comprised of alkylene diamine triacetic acid, or a derivative thereof, and coupling thereof to a carrier via the amine nitrogen. In this context, the term “derivative thereof” is understood to encompass any such derivative which has retained the ability to act as a pentadentate chelator.

Thus, in the method according to the invention, the IMAC ligands are synthesized and, if necessary, purified before they are attached to the carrier. Accordingly, one advantage of the invention is that it avoids deprotection and/or carboxylation on a solid phase, which solid phase chemistry is likely to result in a less homogenous product than the invention.

The alkylene diamine triacetic acid may be prepared by any conventional method of synthesis. Thus, in a first embodiment, the alkylene diamine triacetic acid is prepared as described in EP 1 244 612. In an alternative embodiment, the alkylene diamine triacetic acid is prepared as described in EP 0 546 867. In an advantageous embodiment of the present method, the alkylene diamine triacetic acid is ethylene diaminetriacetic acid (ED3A).

The carrier of the present method may be porous or non-porous, and made from any suitable material. In one embodiment, the carrier is comprised of a cross-linked carbohydrate material, such as agarose, agar, cellulose, dextran, chitosan, konjac, carrageenan, gellan, alginate etc. The support is easily prepared according to standard methods, such as inverse suspension gelation, or obtained as a commercially available product. Carbohydrate carriers, such as agarose, are commonly activated by allylation before coupling of ligands thereon. As is well known, allylation can be carried out with allyl glycidyl ether, allyl bromide or any other suitable activation agent following standard methods. Thus, in one embodiment of the present method, the carrier is a carbohydrate carrier which has been allylated before the coupling reaction.

Alternatively, the carrier of the present method is comprised of cross-linked synthetic polymers, such as styrene or styrene derivatives, divinylbenzene, acrylamides, acrylate esters, methacrylate esters, vinyl esters, vinyl amides etc. Such carriers will commonly present residual vinyl groups available to couple ligands.

The coupling of alkylene diamine triacetic acid to a solid carrier may be carried out using well known methods in this field, see e.g. Immobilized Affinity Ligand Techniques, Hermanson et al, Greg T. Hermanson, A. Krishna Mallia and Paul K. Smith, Academic Press, INC, 1992.

A specific aspect of the present invention is a sulphur-containing alkylene diamine triacetic acid, such as a sulphur-containing ED3A coupled to a carrier via said sulphur.

In order to prepare the chromatography adsorbent so prepared for the use in IMAC, metal ions should be chelated to the ligands. Thus, in one embodiment, the present method comprises a further step of charging the adsorbent so obtained with metal ions. In a specific embodiment, the metal ions are selected from the group consisting of Cu²⁺; Ni²⁺; Zn²⁺; and Co²⁺. In an advantageous embodiment, the metal ions are Ni²⁺.

In a second aspect, the present invention relates to the purification of target biomolecules from crude biological extracts. Thus, in one embodiment, the method comprises coupling of alkylene diamine triacetic acid to a carrier to provide a chromatography adsorbent; charging the adsorbent obtained with metal ions; contacting the charged adsorbent with a mobile phase comprising a variety of biological macromolecules such as protein or peptides to adsorb said protein or peptide to the adsorbent; and optionally eluting protein and/or peptide from the adsorbent. The coupling of alkylene diamine triacetic acid, such as ethylene diaminetriacetic acid (ED3A), to the carrier may be achieved as described above. As discussed in the background section above, IMAC is especially suitable for the separation of target compounds that comprise certain amino acids. Thus, in one embodiment of the present method, the adsorbed protein or peptide comprises two or more histidine, tryptophan and/or cysteine residues, such as four, and advantageously six, histidine residues. In a specific embodiment, the adsorbed protein is a fusion protein comprised of a target protein or peptide entity coupled to a tag entity, wherein the tag entity comprises at least two, preferably at least four, such as six, histidine residues. In an alternative embodiment, the adsorbed protein or polypeptide is a native histidine-containing protein, such as a plasma protein.

A further aspect of the present invention is a process of purifying a histidine, tryptophan and/or cysteine containing protein or peptide from an animal cell culture media, which method comprises a chromatographic purification step wherein the protein or peptide is adsorbed to alkylene diamine triacetic acid ligands, or a derivative thereof, coupled to a carrier by the method according to the invention. The above-discussed details may apply to the process as well. An alternative aspect is a process as described above, wherein the target is a polynucleotide instead of the protein or peptide.

Another aspect of the present invention is the use of an IMAC adsorbent according to the invention as a second chromatographic purification step. In an advantageous embodiment, a column comprising an IMAC adsorbent prepared as described above is used to adsorb metal ions leaked from a preceding IMAC step. The preceding step may be a capture step wherein the protein or peptide is adsorbed to an IMAC adsorbent comprising e.g. IDA, NTA or other IMAC ligands. Thus, the present invention may be used to remove metal leakage from a purification process. Said purification process may be designed e.g. to purify proteins, peptides and/or polynucleotides.

### DETAILED DESCRIPTION OF THE DRAWINGS

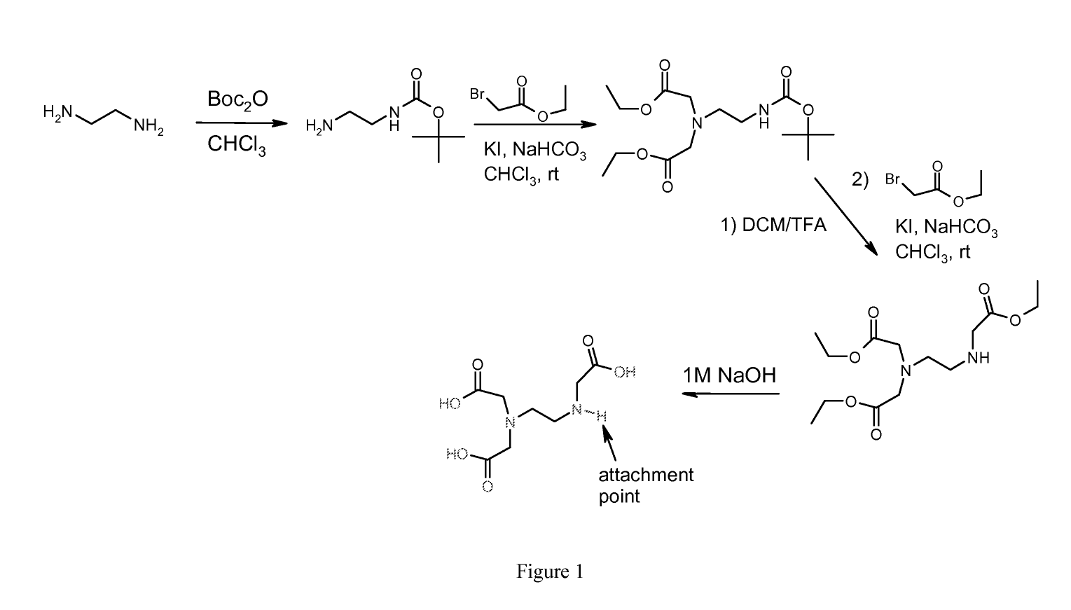

FIG. 1 shows one way of synthesizing an alkylene diamine triacetic acid, namely ED3A, which can be used as a pentadentate IMAC ligand. The synthesis is described in Example 1 below.

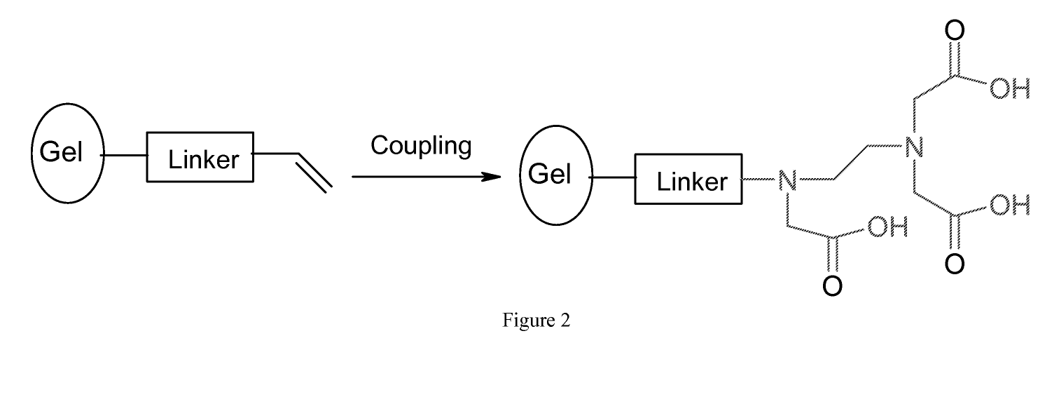

FIG. 2 shows the coupling according to the invention of the purified pentadentate ligand of FIG. 1 to allylated SEPHAROSE™ 6 FF via an amine as a linker atom. Me(II) ion coordination sites are the N and OH groups. Note that there is only 1 free coordination site available on the metal-charged ligand to bind proteins.

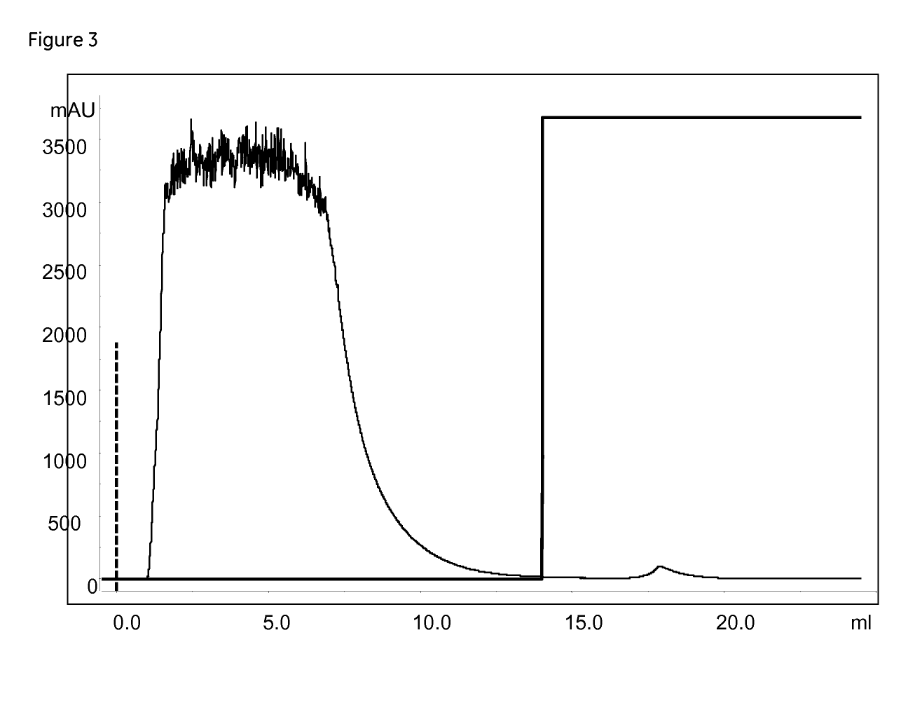

FIG. 3 shows the chromatograms obtained using the IMAC adsorbent according to the invention as described in Example 3 below. As only a very small amount of the E. coli proteins applied to the column is bound, the adsorbent of the invention can be used with only a small amount of host cell protein bound in a purification process.

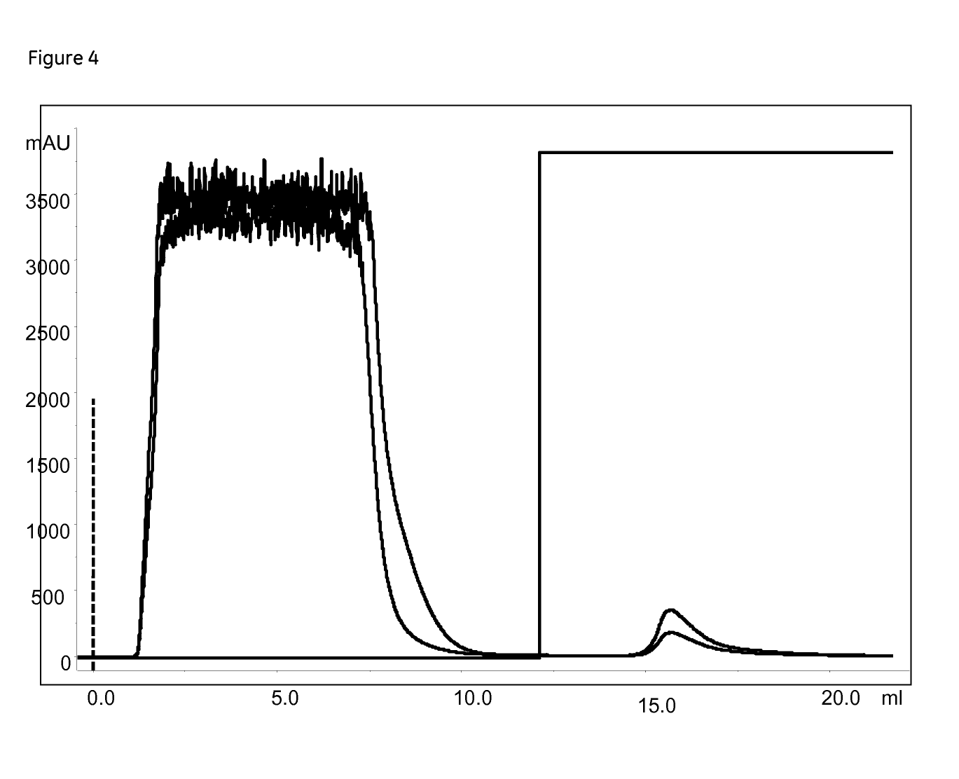

FIG. 4 shows the chromatograms obtained using a commercially available pentadentate as described in Example 4 below. A sizable amount of the applied E. coli proteins is bound, meaning that a substantially higher binding of host cell proteins can be expected than for the adsorbent of the invention.

### EXAMPLES

Below the present invention will be disclosed by way of examples, which are intended solely for illustrative purposes and should not be construed as limiting the present invention as defined in the appended claims. All references mentioned below or elsewhere in the present application are hereby included by reference.

### Example 1

### Synthesis of a Pentadentate Alkylene Diamine Triacetic Acid Ligand

This is schematically shown in FIG. 1. The entire synthesis is performed in solution, as described below:

### ABBREVIATIONS

### CM=Carboxymethylation

### IMAC=Immobilised Metal Ion Affinity Chromatography

NTA=Nitriliotriacetic acid

### AGE=Allyl Glycidyl Ether

### DMF=N,N-Dimethylformamide

### IDA=IminoDiacetic Acid

HFA=High flow Agarose

### TED=Tris-(carboxymethyl)ethylenediamine

HP=High performance
TLC=Thin layer Chromatography

### NMR=Nuclear Magnetic Resonance

TMS=Trimethyl silane
TFA=Trifluoroacetic acid

### DCM=Dichloromethane

ED3A=Ethylene Diamine tri-Acetic acid
MO/Ce=1 g Ce(SO₄)₂ and 21 g (NH₄)₆MO₇O₂₄ 4H₂O in 31 mL H₂SO₄ diluted to 500 mL H₂O

### Materials

Chemistry: Materials/Investigated units

### SEPHAROSE™ 6FF (GE Healthcare Bio-Sciences, Uppsala, Sweden)

Ethylene diamine, Aldrich, Lot. # SO3472-091, Cat.: E, 626-6

### Chloroform, Merck

di-tert-Butyldicarbonate, Aldrich, Cas #24424-99-5

### MgSO₄, Merck

Ethyl bromo acetate, Aldrich, Lot. #11718JA-383, Cat.: 13,397-3

### KI, Merck

### NaHCO₃, Merck

### Toluene, Merck

Ethyl acetate, Merck

### Na₂SO₄, Merck

### NaOH, Merck

### DCM, Merck

### TFA, Merck

### Br₂, Merck

### Allyl Glycidyl Ether, Internal

### Methods

¹H-NMR and ¹³C-NMR spectra were recorded in 6 scale (ppm) with Bruker 300 MHz using TMS as internal reference. All spectra were recorded in CDCl₃ unless otherwise stated. TLC was carried out using Merck precoated silica gel F₂₅₄ plates. Ninhydrin or a mixture of MO/Ce was used to visualise spots on TLC plates. LC-MS data were recorded using Hewlett Packard 1100 MSD electrospray. The flash column chromatographic purifications were carried out using Merck G-60 silica gel.

### Synthesis

### (2-amino-ethyl)-carbamic acid tert-butyl ester (1)

A dry 1 L round-bottomed flask was charged with 24 g (27 mL, 400 mmol) ethylenediamine and dissolved in 400 mL chloroform. To this was added dropwise at 0° C. a solution of 8.70 g (9 mL, 40 mmol) di-tert-butyldicarbonate in 200 mL chloroform over a period of 3 h. After stirring at ambient temperature for 16 h, the reaction mixture was washed with brine (6× 100 mL) and water (1× 100 mL), dried over MgSO₄ and concentrated in vacuo to afford 13.18 g (quantitative yield) of (2-amino-ethyl)-carbamic acid tert-butyl ester (1) as a colourless oil.

### [(2-tert-Butoxycarbonylamino-ethyl)-ethoxycarbonylmethyl-amino]-acetic acid ethyl ester (2)

A dry 250 mL round-bottomed flask was charged with 3.83 g (23.94 mmol) (2-amino-ethyl)-carbamic acid tert-butyl ester (1) dissolved in 50 mL chloroform. To this was added 13.19 g (8.70 mL, 79.00 mmol) ethyl bromo acetate, 3.97 g (23.94 mmol) KI and 12.00 g (143.63 mmol) NaHCO₃. The reaction mixture was stirred at ambient temperature. The reaction was followed to completion on TLC (toluene:ethyl acetate 3:1) and recorded according to the LC-MS data.

The product with R_{f}=0.35 was registered. The solvent was evaporated, the product was extracted with chloroform, was washed with water (2× 100 mL) and dried over Na₂SO₄ was filtrated and evaporated. The product was purified on flash column chromatography (toluene:ethyl acetate 3:1).

Yield: 7.70 g (23.19 mmol), 97%.

### [(2-tert-Butoxycarbonylamino-ethyl)-carboxymethyl-amino]-acetic acid (3)

A dry 250 mL round-bottomed flask was charged with 7.00 g (21.08 mmol) [(2-tert Butoxycarbonylamino-ethyl)-ethoxycarbonylmethyl-amino]-acetic acid ethyl ester (2) dissolved in 100 mL 1M NaOH. The reaction mixture was stirred at ambient temperature for 100 minutes. The reaction mixture was followed to completion until no starting material was visible according to the LC-MS data. The crude product was freeze dried. Yield: 6.80 g (24.64 mmol)

### [(2-Amino-ethyl)-carboxymethyl-amino]-acetic acid (4)

A dry 250 mL round-bottomed flask was charged with 6.40 g (24.64 mmol) [(2-tert-Butoxycarbonylamino-ethyl)-carboxymethyl-amino]-acetic acid (3) dissolved in 50 mL DCM. To this was added 30 mL TFA. The reaction mixture was stirred at ambient temperature. The reaction was followed to completion (for 17 h) on TLC (toluene:ethyl acetate 3:1) and recorded according to the LC-MS data. The product with R_{f}=0.15 was registered. The solvent was evaporated, the product was extracted with CHCl₃, was washed with water (2× 100 mL) and dried over Na₂SO₄ was filtrated and evaporated. The titled compound was purified on flash column chromatography (toluene:ethyl acetate 3:1). Yield: 3.20 g (18.18 mmol), 74%.

### {Carboxymethyl-[2-(ethoxycarbonylmethyl-amino)-ethyl]-amino}-acetic acid (5)

A dry 250 mL round-bottomed flask was charged with 2.50 g (14.20 mmol) [(2-Amino-ethyl)-carboxymethyl-amino]-acetic acid (4) dissolved in 50 mL chloroform. To this was added 1.20 g (790 μL, 7.1 mmol) ethyl bromo acetate, 2.36 g (14.20 mmol) KI and 7.16 g (85.20 mmol) NaHCO₃. The reaction mixture was stirred at ambient temperature. The reaction mixture was followed to completion on TLC (toluene:ethyl acetate 3:1) and recorded according to the LC-MS data.

The product with R_{f}=0.32 was registered. The solvent was evaporated, the product was extracted with chloroform, was washed with water (2× 100 mL) and dried over Na₂SO₄ was filtrated and evaporated. The product was purified on flash column chromatography (toluene:ethyl acetate 3:1).

Yield: 1.85 g (7.06 mmol), 50%.

### {Carboxymethyl-[2-(carboxymethyl-amino)-ethyl]-amino}-acetic acid (6)

A dry 100 mL round-bottomed flask was charged with 50 mg (0.19 mmol) {Carboxymethyl-[2-(ethoxycarbonylmethyl-amino)-ethyl]-amino}-acetic acid (5) was treated in 1 mL 1M NaOH. The reaction mixture was stirred at ambient temperature for 100 minutes. The reaction was followed to completion until no starting material was visible according to the LC-MS data. After complete hydrolysis, the above reaction mixture was diluted to 5 mL with H₂O. The pH was adjusted to 12.5 and the reaction mixture was heated at 50° C. for 60 minutes with stirring. The crude product was freeze dried.

### Example 2

### Coupling of the Ligand to SEPHAROSE™ 6 FF

The coupling was performed following routine procedures starting from the agarose carrier SEPHAROSE™ 6 FF, which was activated with allylglycidylether according to standard methods. The allyl activated carrier was further brominated and the ligand, in large excess, was coupled at basic conditions. It appears from FIG. 2 how the coupling according to the invention of the purified ED3A ligand is performed to the allylated SEPHAROSE™ 6 FF carrier, via an amine as a linker atom. Me(II) ion coordination sites shown in FIG. 2 are the N and OH groups. Note that there is only 1 free coordination site on the ligand to bind proteins.

### Example 3

### Use of the IMAC Adsorbent According to the Invention

This example shows how chromatography of “Wild Type” E. coli extract (containing no His₆-tagged r-protein) carried out on an adsorbent prepared as described above.

Adsorbent: Prototype #1223081 (v. high sub) loaded with Ni(II).
Ni-ion capacity=ca. 21 μmoles/mL
Column: HR 5/5, packed to 1 mL
Sample: The preparation of the E. coli extract was performed according to the Recommended Operation Procedures for Ni-SEPHAROSE™ HP (GE Healthcare, Uppsala, Sweden). No imidazole was added to this extract.
Volume of the extract applied=4 mL (using a 10 mL superloop).
Flow rate=0.5 mL/min (150 cm/h)
Fractions: These were pooled as soon as they were eluted following the A₂₈₀ tracing.
Buffer A (equilibration): 50 mM Na-phosphate, 0.5 M NaCl, pH 7.0
Buffer B (elution): 20 mM Na-phosphate, 50 mM imidazole, 0.5 M NaCl, pH 7.4

The results appear from the chromatogram shown in FIG. 3. Only a very small amount of the E. coli proteins applied to the column is bound. Further, the bound material elutes almost quantitatively upon washing the column with Buffer B.

### Example 4

### Comparative Example

In this experiment, a commercially available pentadentate IMAC adsorbent was used in chromatography of “Wild Type” E. coli extract (containing no His₆-tagged r-protein) on the pentadentate chelator PDC (Affiland).

### Medium: AffiLand PDC

Ni ion capacity=ca. 18 μmoles/mL
Column: HR 5/5, packed to 1 mL
Sample: The preparation of the E. coli extract was performed according to the Recommended Operation Procedures for Ni-SEPHAROSE™ HP (GE Healthcare, Uppsala, Sweden). No imidazole was added to this extract.
Volume of the extract applied=4 mL (using a 10 mL superloop)
Flow rate=0.5 mL/min (150 cm/h)
Fractions: These were pooled as soon as they were eluted following the A₂₈₀ tracing.
Buffer A (equilibration): 50 mM Na-phosphate, 0.5 M NaCl, pH 7.0
Buffer B (elution): 20 mM Na-phosphate, 50 mM imidazole, 0.5 M NaCl, pH 7.4

The results appear from the chromatogram shown in FIG. 4. A sizable amount of the applied E. coli proteins is bound. This fraction is higher than on the adsorbent used in Example 3 above. Further, the bound proteins appear to be completely eluted upon washing the column with Buffer B.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1: A method of preparing an immobilised metal ion affinity chromatography (IMAC) adsorbent, which comprises providing chromatography ligands comprised of alkylene diamine triacetic acid, or a derivative thereof, and coupling thereof to a carrier via the amine nitrogen.

2: The method of claim 1, wherein the alkylene diamine triacetic acid is ethylene diaminetriacetic acid (ED3A).

3: The method of claim 1, wherein the carrier is an allylated carbohydrate carrier.

4: The method of claim 1, further comprising a step of charging the adsorbent so obtained with metal ions.

5: The method of claim 4, wherein the metal ion is selected from the group consisting of Cu²⁺; Ni²⁺; Zn²⁺; and Co²⁺.

6: A method of purifying proteins, peptides and/or polynucleotides, which method comprises coupling of alkylene diamine triacetic acid to a carrier to provide a chromatography adsorbent; charging the adsorbent obtained with metal ions; contacting the charged adsorbent with a mobile phase comprising protein or peptides to adsorb said protein or peptide to the adsorbent; and eluting the protein or peptide from the adsorbent.

7: The method of claim 6, wherein the adsorbed protein or peptide comprises two or more histidine, tryptophan and/or cysteine residues.

8: The method of claim 6, wherein the adsorbed protein is a fusion protein comprised of a target protein entity coupled to a tag entity, wherein the tag entity comprises at least two, preferably at least four, histidine residues.

9: The method of claim 6, wherein the adsorbed protein is a native histidine-containing protein.

10: A process of purifying a histidine and/or cysteine containing protein or peptide from an animal cell culture media, which method comprises a step of chromatography wherein the protein or peptide is adsorbed to alkylene diamine triacetic acid ligands, or a derivative thereof, coupled to a carrier by the method of claim 1.

11. (canceled)
